(19) United States
(12) Patent Application Publication
(10) Pub. No.: US 2007/0192232 A1
(43) Pub. Date: Aug. 16, 2007

(54) System and method to create markets and trade intercommodity spreads

(76) Inventors: Andrew Czupek, New Lenox, IL (US); Bryan T. Durkin, Orland Park, IL (US)

Correspondence Address: MCCRACKEN & FRANK LLP, 200 W. ADAMS STREET, SUITE 2150, CHICAGO, IL, 60606, US

(21) Appl. No.: 11/355,655

(22) Filed: Feb. 16, 2006

(51) Int. Cl. G06Q 40/00

(52) U.S. Cl. 705/37

(57) ABSTRACT

A method for creating a market associated with a first product, a second product, and a parameter, wherein the first product and the second product are related by the parameter, includes the steps of establishing settlement prices for the first and second products and receiving a value for the parameter and an order, wherein the order comprising desired prices for the first and second product. The method also includes the steps of calculating a net difference in price between the order and the settlement prices, wherein the net difference in price is based on the desired prices, the settlement prices, and the value of the parameter; selecting an order book from a plurality of order books that are associated with the first product and the second product, wherein the order book is selected in accordance with the value of the parameter; and adding the order in the order book, wherein each entry in the order book comprises the net difference in price.

### CROSS REFERENCE TO RELATED APPLICATIONS

Not Applicable

### REFERENCE REGARDING FEDERALLY SPONSORED RESEARCH OR DEVELOPMENT

Not Applicable

### SEQUENTIAL LISTING

Not Applicable

### BACKGROUND OF THE INVENTION

1. Field of the Invention

The present invention relates generally to trading systems and more particularly to a system that enables traders to create a market for and trade inter-commodity spreads.

2. Description of the Background of the Invention

Traditional exchanges provide a location for buyers and sellers to meet and, through an open outcry auction process, negotiate prices for products. Examples of the products traded in the exchanges include financial instruments such as stocks, bonds, options, cash, and other similar instruments. Agricultural products and commodities are also examples of financial instruments traded in the exchanges. A futures contract is a financial instrument that is a contract for the future delivery of another financial instrument such as a quantity of grains, metals, oils, bonds, or cash.

Financial instruments may be traded either in the traditional exchanges described above or in electronic exchanges. In an electronic exchange, a trader submits an order that is a bid or an offer that indicates an interest in buying or selling, respectively, a financial instrument. The order identifies, at least, the financial instrument, the quantity of the financial instrument the trader wishes to trade, a price at which the trader wishes to trade the financial instrument, and a direction of the order (i.e., whether the order is a bid or an offer). Each order for a financial instrument accepted by the electronic exchange becomes an entry in an order book of a market associated with the financial instrument. Typically, the order book is a database of all of the pending bids and offers for the financial instrument. At a minimum, each entry of the order book contains the quantity, price, and direction (i.e., whether the entry is a bid or an offer). The electronic exchange stores transaction information related to the order including a time when the order was received, identification information of the trader who submitted the bid or offer, identification information of a firm and a clearinghouse with which the trader is associated, etc.

A trading host in the electronic exchange monitors orders received thereby to identify a bid for a financial instrument at particular price with an offer for the same financial instrument at the same or lower price. Upon identification of the bid and the offer, a minimum of the quantities associated with the identified bid and offer is matched and that quantity of each of the bid and offer become two halves of a matched trade that is sent to a clearinghouse. Any remaining quantity of the bid or offer remains in the order book until the bid or offer is matched with another offer or bid, respectively, or the bid or offer is cancelled.

Just as an open-outcry exchange has multiple trading pits, where each trading pit, or even a portion thereof, is designated to trade certain products, electronic exchanges have multiple markets where each market trades is designated to trade certain financial instruments and an order book is associated with each market. For example, a futures electronic exchange may have separate markets to trade futures contracts for delivery of 10 Year Treasure Notes in March, 2006, 2 Year Notes in June, 2008, Gold in February, 2010, Oats in March, 2007, etc.

Traders access the markets in an electronic exchange using trading software that obtains and displays at least a portion of the order book for a market, enables a trader to provide parameters for an order for the financial product traded in the market, and transmits an order to the electronic exchange. The trading software typically includes a graphical user interface to display at least a price and quantity of some of the entries in the order book associated with the market. The number of entries of the order book depicted is generally preconfigured by the trading software, limited by the electronic exchange, or customized by the user. Some graphical user interfaces display order books of multiple markets of one or more exchanges.

The trading software communications with the trading host of the electronic exchange using an application programmer's interface provided by the exchange or by the developer of the trading host software. The API consists of a library of software procedures that implement protocols used to exchange messages between the trading software and the trading host. The trading software uses the procedures in the API to submit orders, cancel orders, modify orders, obtain status of submitted orders, obtain the order book (or a portion thereof), obtain information about market activity, etc.

A spread is an order submitted by the trader that includes multiple bid and offer components called “legs,” wherein each leg is a bid or offer for a financial instrument. Each leg of a spread may be traded individually on a market designated for the financial instrument represented by the leg. Alternately, the spread may be traded as a single financial instrument on a market that is designated to trade orders for that type of spread.

The direction of the spread order determines the direction of all of the legs that comprise the spread. The direction of some legs is identical to the direction of the spread (i.e., a bid for the spread order means a bid for the leg) and the direction of other legs is in the opposite direction (i.e., a bid for the spread order means an offer for the leg). How the directions of individual legs of the spread order are related to the direction of the spread order is predefined when the financial instrument representing the spread is defined. Typically, a spread order that comprises two legs will have one leg that is in the same direction as the spread order and another leg that is in the opposite direction than the spread order.

The quantity of a spread order determines the quantity of the order associated with each leg. In some cases, the quantities associated with all of the legs of the spread are identical to the quantity of the spread order. In other cases, the quantity associated with each leg of a spread order is determined according to a mathematical relationship with the quantity of the spread order.

A trader evaluating the value of an order for a financial instrument that represents a discreet financial instrument (e.g., a share of IBM stock, a contract for delivery of Soybeans in January, 2006) is generally interested in the price of the financial instrument. In contrast, a trader evaluating the value of a spread order is interested in the difference in value among the legs that comprise the spread. Therefore, an order book for a market for spreads generally lists the spread orders available for purchase or sale in accordance with the difference in value of the legs. For example, consider a first order to buy a first spread with one leg to buy a futures contract for delivery of soybeans in January, 2006, at $562 and another leg to sell a futures contract for delivery of soybeans in May, 2006, at $575: In addition, consider a second order to buy a second spread comprising one leg to buy a futures contract for soybeans in January, 2006, at $400 and a another leg to sell a futures contract for delivery soybeans in May, 2006, for $413. From the perspective of a trader evaluating these two spread orders, the two orders are equivalent because the difference in value of the component legs of each spread order is $−13 ($562-$575 and $400-$413). The order book for the market for futures contracts for delivery of soybeans in January, 2006, would show an entry to buy two spreads at $−13. Furthermore, a trading host that receives an order to sell two spreads, wherein the difference in value between the legs is ($−13) would match with received order with the two spreads in the order book regardless of the price of the legs comprising the spread.

Typically, a trader uses spread orders to reduce risk. A trader may also use spread orders for arbitraging between the markets for the financial products of the legs of a spread and the market where the spread is traded as an individual financial instrument. This is possible because changes in prices of certain financial instruments are related. For example, during normal market conditions, changes in the price of 10-Year Treasury Notes (ZN) and the price of 30-Year Bonds (ZB) for delivery in the same month are at a ratio of 1:1.71, so that a change in the price of 10-Year Treasury Notes of 1 basis point results in a change in the price of 30-Year Bonds of 1.71 basis points. The ratio between these two products exists because of the expected returns (i.e., yield curves) of the two products. However, under atypical market conditions the changes in prices of the two products may deviate from the ratio of 1:1.71 temporarily. A trader can use a type of spread known as an inter-commodity spread (ICS), to profit from such variations in the ratio (when the ratio is used to specify a spread the term “spread ratio” is used). Specifically, a trader may specify an ICS that has one leg to trade a futures contract for delivery of ZN in September '06 and another leg to trade a futures contract for delivery of ZB in September '06, with a spread ratio of 1.71. Such an ICS is hereinafter referred to as “NOB September '06 1.71” to indicate a Notes over Bonds ICS for deliveries in September '06 having a spread ratio of 1.71 associated therewith. For example, if the markets are such that the changes in price between ZN September '06 (i.e., a futures contract for delivery of ZN in September, 2006) and ZB September '06 are related by a spread ratio of 1.69, the trader can trade a NOB September '06 1.69 ICS to buy ZN September '06 and sell ZB September '06 when the spread ratio is 1.69 and then trade a NOB September '06 1.71 ICS to sell ZN September '06 and buy ZB September '06 when the spread ratio of prices changes of ZB and ZN returns to 1.71. It should be apparent that the trader who uses two ICS orders to undertake these trades carries less risk than one who has two use four separate orders because the legs of the ICS orders are traded simultaneously. Thus, the relationship between the legs of the ICS is guaranteed.

Some exchanges provide a market for trading an ICS as a single financial instrument; however, these markets restrict the spread ratios between the legs of the ICS to those predetermined by the exchange. For example, the Sidney Futures Exchange (SFE) supports trading of inter-commodity spreads between futures contracts for Australian 10-Year Bonds and U.S. 10-Year Bonds with a fixed spread ratio of 1:1 between the two financial instruments.

Some trading software enables traders to define a synthetic market for an ICS with a particular spread ratio selected by the trader and to define an order for a purchase or sale of an ICS with the particular spread ratio. The trading software thereafter creates an order for each leg of the spread independently on the market for the financial instrument designated by the leg. That is, the trading software product submits a first order for a first leg of the ICS into a first market. If the first order is matched successfully, then the trading software submits a second order for the second leg of the ICS into a second market, wherein the quantity of the second leg is based on the quantity of the first leg and the spread ratio specified by the trader. Because the two legs of the spread are traded separately in separate markets, the trading software cannot guarantee that the orders of the two legs of the spread are executed at the desired price and quantity. This lack of guarantee significantly increases risk for the trader who wishes to trade ICS financial products.

### SUMMARY OF THE INVENTION

According to one aspect of the invention, a method for creating a market associated with a first product, a second product, and a parameter, wherein the first product and the second product are related by the parameter. The method comprising the steps of establishing settlement prices for the first and second products. The method further comprises a step for receiving a value for the parameter and an order that comprises desired prices for the first and second products and a step for calculating a net difference in price between the order and the settlement price, wherein the net difference in price is based on the desired prices, the settlement prices and the value of the parameter. In addition, the method comprises a step of selecting an order book from a plurality of order books that are associated with the first product and the second product in accordance with the value of the parameter. Furthermore, the method comprises the step of creating an entry of the order in the order book, wherein each entry in the order book comprises the net difference in price.

According to another aspect of the invention, a method for creating a market associated with a group of products and a parameter, wherein the group of products are related by the parameter. The method comprises the step of receiving a value for the parameter and an order that comprises desired prices for the group of products. The comprises the further step of selecting an order book from a plurality of order books that are associated with the group of products, wherein the order book is selected in accordance with the value of the parameter.

Other aspects and advantages of the present invention will become apparent upon consideration of the following detailed description.

### BRIEF DESCRIPTION OF THE DRAWINGS

FIG. 1 shows a logical block diagram of a system used to trade ICS financial instruments;

FIGS. 2A-2D illustrate examples of orders of ICS financial instruments;

FIG. 3 shows an order book with entries comprised of the orders illustrated in FIGS. 2A-2D;

FIG. 4 depicts a flowchart of a system that may be used to implement of a trading host of the system shown in FIG. 1; and

FIG. 5 shows a table that may be provided to a trader of ICS financial instruments.

### DETAILED DESCRIPTION OF THE PREFERRED EMBODIMENTS

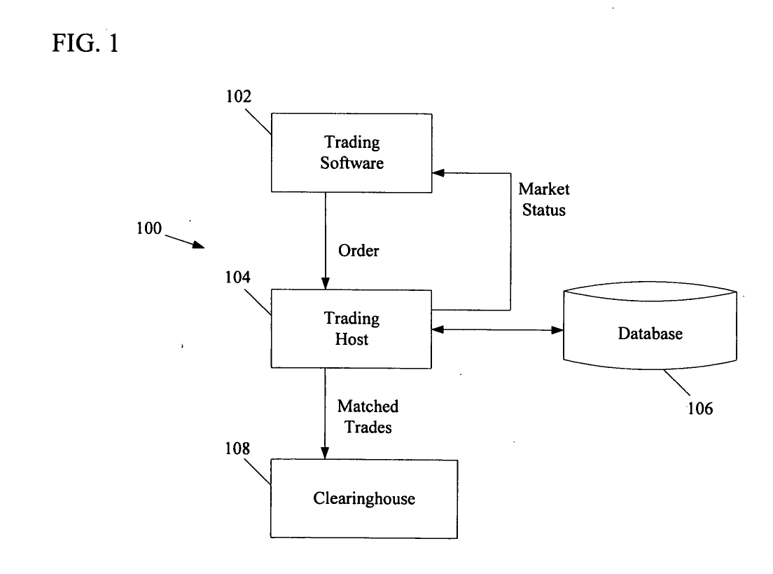

FIG. 1 shows a logical block diagram of a system 100 used to trade ICS financial instruments. A trader uses trading software 102 to submit an order to a trading host 104. In response to receiving an ICS order, if a market for the ICS financial instrument specified by the order does not exist, the trading host 104 creates a market by creating table in a database 106 for managing order book entries for the market. Otherwise, the trading host 104 compares the ICS order to any pending ICS orders to determine if a quantity of the received ICS order can be matched with a quantity of the pending order and if a quantity can be matched sends a message reporting the match to a clearinghouse 108. If the quantity cannot be matched or if a quantity remains after a match, the trading host 104 creates an entry for the remaining quantity in the order book. In addition, the trading host 104 provides information regarding entries in the order book (i.e., market status) to the trading software 102 so that traders can monitor ICS orders that are pending in the market.

A trader uses the trading software 102 to submit an ICS spread order by submitting a desired price and quantity for a first leg, a price for the second leg, and a spread ratio desired for the ICS. The trading host 104 validates the parameters of the ICS order, e.g., confirms that the contracts designated by the legs are actual financial instruments allowed for the ICS, and calculates the quantity desired of the second leg of the ICS order. In particular,
Q₂=Q₁/R (1)
where Q₁ is the quantity of the first leg and R provided by the trader. The trading host 104 determines if a market already exists for the ICS with the desired spread ratio by querying the database 106 to determine if an order-book exists for the ICS with the spread ratio specified by the trader.

If the order book exists, the trading host 104 adds the new ICS order to the order book table in the database 106. Otherwise, the trading host creates a new order book in the database 106 by creating a new table for an order book for a market for trading ICS's with the spread ratio in the order-book database. In some embodiments, the trading host creates a new order-book (i.e., a new market) only if a difference between the spread ratio and a spread ratio associated with another market for the ICS exists in the database is more than a predetermined threshold (e.g., 0.01). It should apparent that the trading host 104 can use other criteria to determine whether to create a new order book in response to an ICS order or whether to add the ICS order to an existing order book.

As discussed above, order book entries for spread orders reflect the value of the spread instead of the prices of underlying spreads. In one embodiment, the value of an ICS order is calculated based on the previous day's settlement prices for the products specified by the legs thereof. Specifically, the value of the ICS order is a net difference in price between the ICS order and the previous day's settlement prices of the financial instruments associated with legs of the ICS order and is calculated as follows:
D=(P₁−S₁)−(P₂−S₂)/R (2)
where D is the net difference in price, S₁ and S₂ are the previous days settlement prices for the financial instruments associated with the first and second legs of the ICS order, respectively, P₁ and P₂ are the prices for the first and second legs of the ICS order, respectively, and R is the spread ratio.

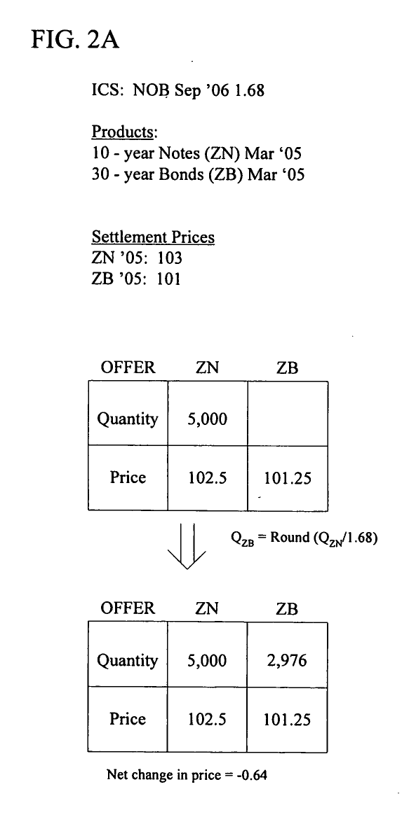

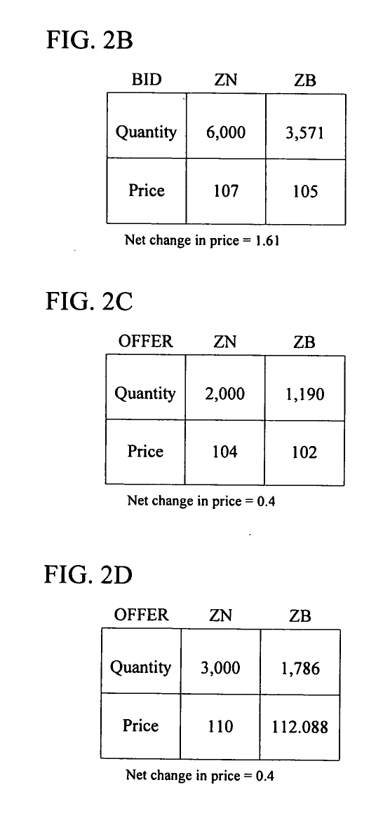

FIGS. 2A-2D show orders examples of orders submitted to trade NOB-1.68 ICS financial instrument. In these examples, the previous day's settlement prices of ZN and ZB are 103 and 101, respectively. FIG. 2A shows an example of an order to sell 5,000 NOB-1.68 September '06 ICS's. A trader uses trading software to submit this order by specifying a quantity of one leg (i.e., quantity of ZN) and the desired prices for each of the legs (102.5 and 101.25). Upon receiving such an order, the trading host calculates the quantity of the second leg (i.e., the quantity of ZB) based on the spread ratio of 1.68. As was noted above, in some exchanges the calculated quantity of ZB is rounded to the nearest whole number and in this example the calculated quantity is rounded to 2,976. In accordance with the previous day's settlement prices, the net difference in price for the spread order is −0.64. If this order is the first order received by the electronic exchange for a NOB-1.68 ICS, the trading host 104 creates and initializes a new order book in the database 106 and creates an entry for the received ICS order to the new order book.

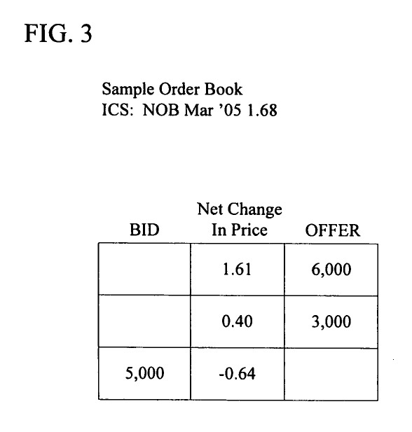

FIG. 2B shows an example of an offer to sell 6,000 NOB-1.68 September '06 ICS. The trading host 104 calculates the quantity of ZB to be 3,571 based on the 6,000 contracts of ZN and the spread ratio. In addition, the net difference in price of the ICS order shown in FIG. 2B is 1.61. FIG. 2C shows an example of an order of an offer of 2,000 NOB-1.68 September '06 ICS's, wherein the trader has requested prices of 104 and 102 for ZN and ZB, respectively. FIG. 2D shows another example of an order of an offer of 3000 NOB-1.68 September '06 ICS's where the trader has requested prices of 110 and 112.088 for ZN and ZB, respectively. The two orders shown in FIGS. 2C and 2D yield the same net difference in price of 0.4 and these two orders appear as a single entry in the order book to sell 5,000 ICS's at 0.4 in the order book. FIG. 3 shows an example of the order book listing orders for the NOB-1.68 orders depicted in FIGS. 2A-2D. The data in the order book of FIG. 3 is provided to the software being used by traders so that the traders may monitor activity in the market for the ICS and submit additional orders.

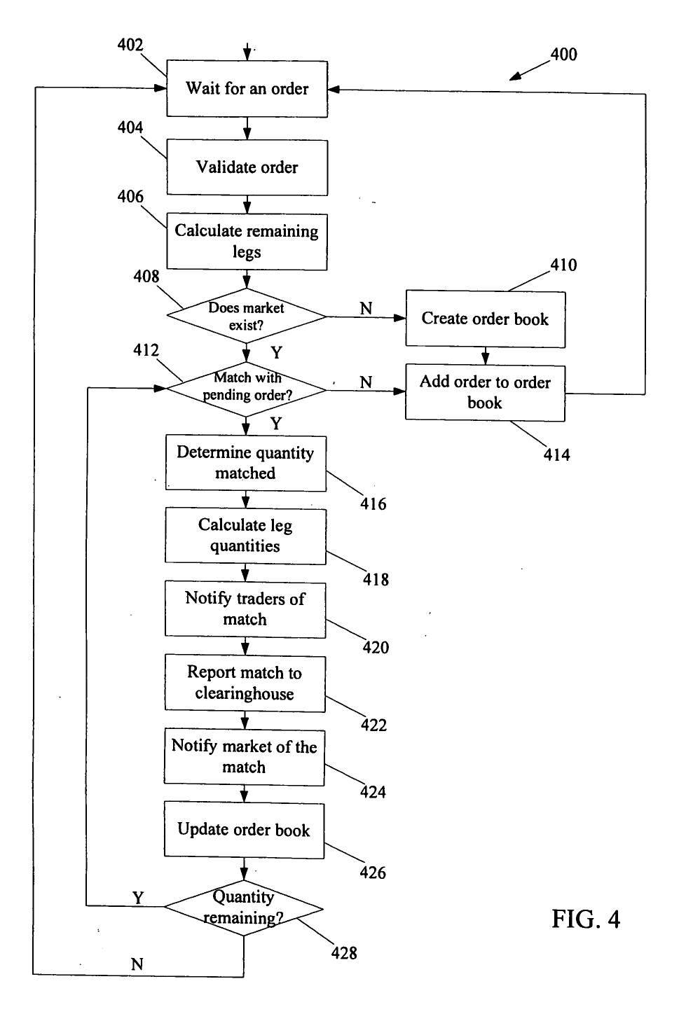

FIG. 4 depicts a flowchart 400 that shows the steps used to implement the trading host 104 depicted in FIG. 1. With continuing reference to FIG. 1, the trading host 104, at a block 402, monitors communications queues for an ICS order to arrive. When an ICS order arrives, the trading host 104 validates the parameters thereof in a block 404. If the parameters are not valid, the trading host 104 reports an error to the trading software 102 used by the trader who submitted the order by sending a message thereto using the communications queues. If the parameters are valid, the trading host 104 proceeds to a block 406 and calculates the quantity associated with each remaining leg of the ICS order in accordance with the parameters of the received ICS order. Thereafter, at a block 408, the trading host 104 queries the order database 106 to determine if a market (and therefore an order book) exists for trading ICS financial instrument with the specific spread ratio (or within a predetermined range about the spread ratio). The trading host proceeds to a block 410 if the order book does not exist, otherwise, the trading host 104 proceeds to a block 412. At the block 410, the trading host 104 creates a new table in the order database 106 and then proceeds to a block 414 to add the order to the newly created table representing the order book. In addition, at blocks 410 and 414, the trading host 104 may create additional entries in the order book and other tables of the database 106 necessary to manage transactions related to the market represented by the newly created order book or to track, audit, and report transactions as required by the exchange or the clearinghouse. The additional entries include identification information of the trader, account numbers, whether the trader is a local or is associated with a firm, firm identification information, order modifiers, etc. After the block 414, the trading host 104 returns to the block 402 to await an additional order.

If, at the block 408, the trading host 104 determines that the market exists for the received order (i.e., the order book has been created in response to another ICS order received earlier), the trading host 104 proceeds to the block 412 and determines if the received order or a portion thereof can be matched with any pending orders in a manner that is described in detail below. If the received order cannot be matched with any pending orders, then the trading host 104 adds the received order to the order book at the block 414 and returns to the block 402 to wait for another order to be received.

To determine whether the received order can be matched with a pending order in the block 412, the trading host 104 selects an order book entry that has a net difference in price that is favorable and in an opposite direction compared to the received ICS order. For a received order that is an order to buy a quantity of ICS's, an order book entry has a favorable net difference in price if the net difference in price thereof is less than or equal to that of the received order. Similarly, for a received order that is an offer, an order book entry has a favorable net difference in price if the net difference in price thereof is greater than or equal to that of the received order. Typically, if there are multiple entries in an order book having a favorable net difference in price compared to the received order, the entry with the most favorable net difference in price is selected first. In a preferred embodiment, the trading host 104 further selects each pending ICS order that comprises the selected order book entry in accordance with the time when the trading host received the pending order. At a block 416 the trading host 104 determines the minimum of the quantities of the received ICS order and the selected pending ICS order. The minimum of the two quantities is the quantity of the received ICS order and the selected pending ICS order that is matched. An alternate selection method selects an entry in order book that has a favorable net difference in price and allocates the minimum of the total quantity of the pending ICS orders that comprise the selected order entry and the received ICS order among the pending ICS orders that comprise the selected order book entry. That is, a portion of the minimum is allocated to an order comprising the selected entry of the order book in accordance with a proportion between the quantity of the order and the total quantity of all of the order comprising the selected entry. Other selection methods to select pending orders to match with a received order are known to those with skill in the art and are generally defined in accordance with rules of the exchange.

For each pending ICS order selected for matching, the trading host 104, at a block 418, uses the matched quantity and the spread ratio to calculate the quantity of the legs of the pending ICS order that is matched. Specifically, if an ICS's has two legs, the quantity matched of one leg is identical to the matched quantity and the quantity of the other leg is calculated by dividing the matched quantity by the spread ratio associated with the ICS. Similar calculation methods can be used at the block 418 for an ICS order with more than two legs. In a preferred embodiment, the direction of rounding for the calculated quantity of a leg is alternated for each pending order that is matched. For example, the calculated quantity is rounded up for the first pending order matched to a received order, then rounded down for the next pending order matched, and so on.

The trading host 104, at a block 420, notifies the traders who submitted the received order and the pending order matched thereto. The trading host 104 transmits a message to the trading software 102 used by the traders who submitted the received order and the matched pending order that includes the net difference in price of the pending order that matched, the quantity of the order matched, and the prices and quantities of the financial instruments associated with the legs of the matched order.

The trading host then proceeds to a block 422 to construct and transmit a message to the clearinghouse 108 that specifies the product, quantity, price of each leg of the pending order matched and information identifying the buyer and seller of the leg.

Thereafter, the trading host 104, at a block 424, notifies the participants in the market for the ICS by sending a message to the trading software 102 used thereby that specifies the quantity matched and the net difference in price of each pending order matched. The trading host 104 thereafter proceeds to a block 426 where the quantity of the pending ICS order matched is subtracted from the entry in the order book associated therewith to calculate the remaining quantity of the entry. The trading host 104, also at the block 426, updates the entry in the order book with the remaining quantity and proceeds to the block 428. At a block 428, the trading host 104 subtracts the quantity matched from the quantity of the received order to calculate a quantity remaining of the received order and if the remaining quantity of the received order is not zero then the trading host returns to the block 414 to determine if there are additional pending orders that may be matched with the received order. If the remaining quantity of the received order is zero, then the trading host 104 returns to the block 402 to wait for receipt of another order.

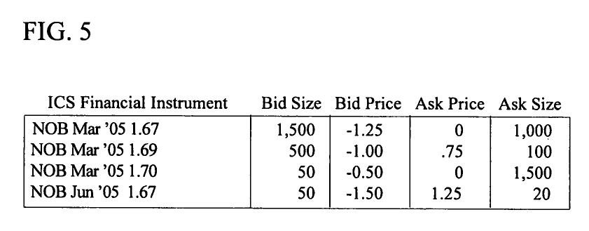

As described above, the trading host 104 manages a plurality of markets and order books for ICS financial instruments, wherein the legs of the spread trade are orders for the same financial instrument but the legs are related to one another by different spread ratios. A trader may wish to trade in a number of such ICS financial instruments to optimize his or her own portfolio. The market status data provided by the trading host 104 described above enables a trader to do this. FIG. 5 illustrates a table that trading software 102 used by the trader could provide thereto using the market status information. The first three entries of the table show the quantity and net difference in price of the best (i.e., most favorable) bids and offers for NOB March 05 ICS financial instruments with spread ratios of 1.67, 1.69, 1.70, respectively. The fourth entry shows an NOB June '05 1.67 ICS. The trader may monitor a table such as this using the trading software 102 to decide whether to submit a bid in any of these markets or to create a new market. In addition, the trading software 102 may aggregate information from multiple trading hosts on one or more exchanges to compile the table that is displayed to the trader. In addition, it should be apparent to those with skill in the art that a trader may create a market for an ICS other than NOB used as a reference hereinabove. Examples of other ICS financial instruments include corn over wheat, 5-Year Notes over 10-Year Notes, 5-Year Notes over 30-Year Bonds, etc. Furthermore, a trader may create an ICS market wherein the products traded by the financial instruments are identical (e.g., 5-Year Notes) but the delivery dates are different or similarly, wherein both products traded by the financial instruments and the delivery dates thereof are different. In addition, a trader can create ICS financial instruments that represent complex strategies that are known in the art such as condor or butterfly spreads.

An exchange may specify that ratios selected by the trader to create a market for an ICS financial instrument be within a particular range. Similarly, the exchange may specify certain ratios that a trader may select to create an ICS financial product comprising legs that trade particular products.

In addition, a first exchange may cooperate with a second exchange to allow a trader to create a market for an ICS financial instrument that spans the two exchanges, wherein a first set of legs of the ICS financial instrument are traded on the first exchange and a second set of legs of the financial product are traded on the second exchange. In this case, settlement prices used to value the ICS financial instrument may use the previous day's settlement prices of the financial instruments represented by the first and second sets of legs that are determined on the first and second exchanges, respectively. In this case, the functions of the trading host described hereinabove may be distributed among the trading hosts used by the first and second exchange.

In addition, traders may wish to create markets for ICS financial instruments that comprise legs that are orders to trade futures contracts for the same product but with different delivery dates.

In a preferred embodiment, the trading host 104 is the LIFFE CONNECT® system provided by LIFFE Administration and Management of London, United Kingdom. The communications among the trading software, trading host, the clearing houses preferably use communications middleware provided by MQ Server from IBM Corporation of Armonk, N.Y., as part of its WebSphere product. It should be apparent to those with skill in the art that intermediate systems may be used to provide the infrastructure to facilitate or optimize receiving orders from the trading software by the trading host, reporting market activity from the trading host, reporting matched trades to a clearinghouse, etc.

### INDUSTRIAL APPLICABILITY

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved.

I/we claim:

1. A method for creating a market associated with a first product, a second product, and a parameter, wherein the first product and the second product are related by the parameter, the method comprising the steps of:
establishing settlement prices for the first and second products;
receiving a value for the parameter and an order, the order comprising desired prices for the first and second product.
calculating a net difference in price between the order and the settlement prices, wherein the net difference in price is based on the desired prices, the settlement prices, and the value of the parameter;
selecting an order book from a plurality of order books that are associated with the first product and the second product, wherein the order book is selected in accordance with the value of the parameter; and
adding the order in the order book, wherein each entry in the order book comprises the net difference in price.

2. The method of claim 1, wherein the method comprises the further step of creating an order book if an order book in accordance with the value of the parameter does not exist.

3. The method of claim 1, wherein the step of selecting an order book selects the order book in accordance with a range of values determined by the parameter.

4. The method of claim 1, wherein the value for the parameter is selected from a range of values.

5. The method of claim 1, wherein the value for the parameter is selected from a plurality of predetermined values.

4. The method of claim 1, wherein a trader provides the parameter.

5. The method of claim 1, wherein the products are financial instruments.

6. The method of claim 1, wherein the products are futures contracts.

7. The method of claim 1, wherein the products are traded in the same exchange.

8. The method of claim 1, wherein the first product is a futures contract.

9. The method of claim 8, wherein the products are not traded in the same exchange.

10. The method of claim 1, wherein the method includes the further step of receiving a second order and calculating a second net difference in price between the second order and the settlement prices.

11. The method of claim 10, wherein the step of adding the second order to the order book includes the step of aggregating the first named order and the second order into a single entry of the order book.

12. The method of claim 11, wherein the net differences in price associated with the first named order and the second named order are equivalent.

13. The method of claim 10, wherein the method includes the further step of matching a portion of the second order to a portion of the first named order if the net difference in price of the first named order is favorable to the net difference in price of the second named order.

14. The method of claim 13, wherein the method includes the further step of notifying a trader who submitted the first named order or the second of the match.

15. The method of claim 13, wherein the method includes the further step of reporting the matched trade to a clearinghouse.

16. A method for creating a market associated with a group of products and a parameter, wherein the group of products are related by the parameter, the method comprising the steps of:
receiving a value for the parameter and an order, the order comprising desired prices for the group of products; and
selecting an order book from a plurality of order books that are associated with the group of products, wherein the order book is selected in accordance with the value of the parameter.

17. The method of claim 1, wherein the method includes the further step of calculating a net difference in price between the group of products and settlement prices of the products that comprise the group of products.

18. The method of claim 17, wherein the method includes the still further step of adding an entry to the order book, wherein the entry is associated with the net difference in price.

19. The method of claim 17, wherein the method includes the further step of receiving a second order and calculating a second net difference in price between the second order and the settlement prices.

20. The method of claim 19, wherein the step of adding the second order to the order book includes the step of aggregating the first named order and the second order into a single entry of the order book if the net difference in price associated with the first named order and the second order are equivalent.

21. The method of claim 19, wherein the method includes the further step of matching a portion of the second order to a portion of the first named order if the net difference in price of the first named order is favorable to the net difference in price of the second named order.

22. The method of claim 16, wherein the method includes the further step of creating the order book if the order book does not exist.

23. The method of claim 16, wherein financial instruments comprise the group of products.

24. The method of claim 16, wherein futures contracts comprise the group of products.

25. The method of claim 16, wherein products that comprise the group of products are traded in the same exchange.

27. The method of claim 26, wherein a first product comprising the group of products is traded in a first exchange and a second product comprising the group of products is traded in a second exchange.
